(19) United States
(12) Patent Application Publication
(10) Pub. No.: US 2007/0268620 A1
(43) Pub. Date: Nov. 22, 2007

(54) Magnetic disk apparatus

(75) Inventor: Tomohide Nakajima, Higashine (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/521,768

(22) Filed: Sep. 15, 2006

(30) Foreign Application Priority Data
May 16, 2006 (JP) 2006-136401

(51) Int. Cl. G11B 5/012

(52) U.S. Cl. 360/97.01

(57) ABSTRACT

A magnetic disk apparatus comprises an electrically conductive enclosure which accommodates at least a magnetic storage medium and a head for writing/reading information on the magnetic storage medium, an electrically conductive damping plate which is attached via an insulating member to one face of the electrically conductive enclosure in order to suppress vibration of the electrical conductive enclosure, and at least one electrical connecting member which electrically connects the damping plate to the electrically conductive enclosure.

### BACKGROUND OF THE INVENTION

1. Field of the Invention

The present invention relates to a magnetic disk apparatus having a damping plate and, more particularly to a magnetic disk apparatus capable of preventing the discharge of static electricity from the damping plate.

2. Description of the Related Art

A magnetic disk apparatus comprises a rotating magnetic disk and a magnetic head movable across tracks on the magnetic disk to read and write information on sectors on the magnetic disk, and the mechanical components of the magnetic disk apparatus are hermetically sealed within a disk enclosure comprising a metal base and a cover to protect the components from dust and other foreign particles. As is well known in the art, a damping plate, usually made of a metal, is fixed to the cover of the magnetic disk apparatus by means of a double-sided adhesive tape in order to suppress vibrations or noise that can occur when the magnetic disk is rotated at high speed by a motor or when a seek operation is performed for moving the magnetic head from one track to another on the magnetic disk (refer to Japanese Unexamined Patent Publication No. 2001-167554).

The metal damping plate is fixed to the metal cover with a double-sided adhesive tape. The damping plate is therefore in an electrically floating condition. The present inventor has discovered that such an electrically floating damping plate can easily become electrically charged due to an ion balance disruption, friction, etc. during the assembly process. If the charged damping plate contacts another conductor, a discharge occurs. The discharge can adversely affect the magnetic disk apparatus and the electronic components located around the magnetic disk apparatus leading, in the worst case, to the destruction of these devices.

### SUMMARY OF THE INVENTION

It is an object of the present invention to provide a magnetic disk apparatus capable of preventing the discharge of static electricity from such a damping plate.

To achieve the above object, a magnetic disk apparatus according to a first aspect of the present invention comprises: an electrically conductive enclosure which accommodates at least a magnetic storage medium and a head for writing/reading information on the magnetic storage medium; an electrically conductive damping plate which is attached via an insulating member to one face of the electrically conductive enclosure in order to suppress vibration of the electrical conductive enclosure; and at least one electrical connecting member which electrically connects the damping plate to the electrically conductive enclosure.

Preferably, the insulating member is an insulating double-sided adhesive tape, and the electrical connecting member is a protrusion protruding from the damping plate or the electrically conductive enclosure.

The electrical connecting member may be at least one electrically conductive tape which is attached so as to electrically connect a surface of the electrically conductive enclosure and a surface of the electrically conductive member.

A magnetic disk apparatus according to a second aspect of the present invention comprises: an electrically conductive enclosure which accommodates at least a magnetic storage medium and a head for writing/reading information on the magnetic storage medium; and an electrically conductive damping plate which is attached, via an electrically conductive member, to one face of the electrically conductive enclosure in order to suppress vibration of the electrically conductive enclosure.

A magnetic disk apparatus according to a third aspect of the present invention comprises: an electrically conductive enclosure which accommodates at least a magnetic storage medium and a head for writing/reading information on the magnetic storage medium; and an electrically conductive damping plate which is attached to one face of the electrically conductive enclosure in order to suppress vibration of the electrically conductive enclosure, wherein at least an externally exposed surface of the damping plate is covered with a high-resistance material.

In the first aspect of the present invention, the damping plate which is electrically floating is connected to the electrically conductive enclosure through the electrical connecting member. Any charge occurring on the damping plate is therefore quickly released via the electrically conductive enclosure to the ground so that the charge will not be accumulated. Electrostatic discharge due to contact of the charged damping plate with another conductive member can thus be avoided.

In the second aspect of the present invention, the damping plate is attached to the electrically conductive enclosure by interposing an electrically conductive member between them. The electrically conductive member functions not only as an attaching means but also as an electrically conducting means through which any charge occurring on the damping plate is dissipated. Accordingly, not only can the damping plate be attached but accumulation of charge can be prevented in a simple manner.

In the third aspect of the present invention, since at least the externally exposed surface of the damping plate is covered with a high-resistance material, if the damping plate contacts another conductor, an electrostatic discharge that could adversely affect another device does not occur.

### BRIEF DESCRIPTION OF THE DRAWINGS

These and other objects and features of the present invention will become clearer from the following description of the preferred embodiments given with references to the attached drawings, wherein:

FIG. 1 is a diagram of a prior art magnetic disk apparatus before a cover is mounted on the disk enclosure;

FIG. 2 is a diagram of the prior art magnetic disk apparatus after the cover with a damping plate attached thereto is mounted on the disk enclosure;

FIG. 3 is a diagram of the results of the measurements of electrostatic discharge from an electrically charged damping plate of the prior art;

FIG. 4 is a diagram of one example of a first embodiment of the present invention;

FIG. 5 is a diagram of another example of the first embodiment of the present invention;

FIG. 6 is a diagram of a portion to which the first embodiment of the present invention is applied;

FIG. 7 is a diagram of one example of a second embodiment of the present invention;

FIG. 8 is a diagram of another example of the second embodiment of the present invention;

FIG. 9 is a diagram of one example of a third embodiment of the present invention;

FIG. 10 is a diagram of another example of the third embodiment of the present invention;

FIG. 11 is a diagram of a fourth embodiment of the present invention;

FIG. 12 is a diagram of a fifth embodiment of the present invention;

FIG. 13 is a diagram of experimental results demonstrating the effect and advantage of the first to fifth embodiments of the present invention; and

FIG. 14 is a diagram showing a sixth embodiment of the present invention.

### DESCRIPTION OF THE PREFERRED EMBODIMENTS

Embodiments of the present invention will be described below with reference to the drawings but, first, an example of a magnetic disk apparatus that provides the basis for the present invention will be described in order to clarify the effect and advantage of the embodiments of the present invention.

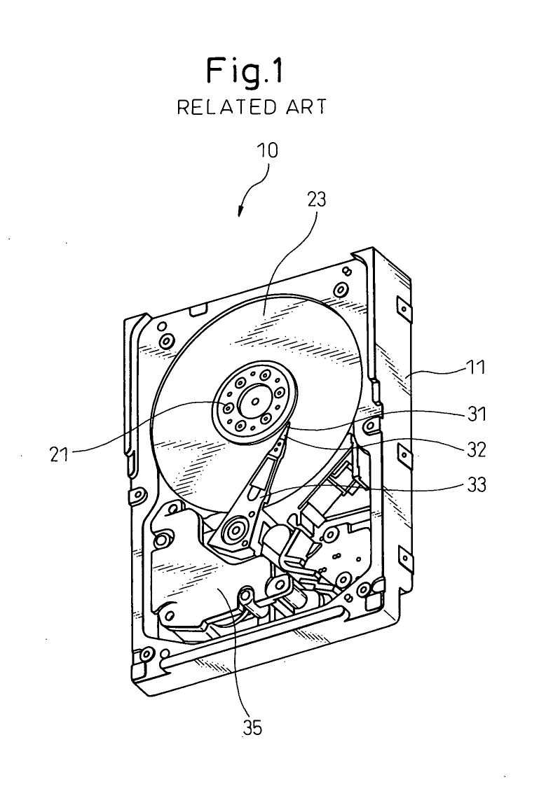

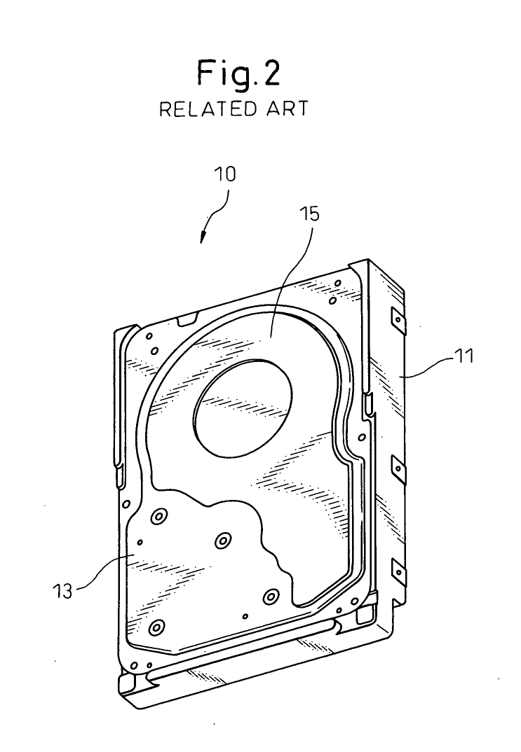

FIG. 1 is a diagram showing an example of the mechanism accommodated in the magnetic disk apparatus to which the present invention is applied, and FIG. 2 is a diagram showing the magnetic disk apparatus mounted with a cover for hermetically sealing the mechanism. As shown in FIG. 1, a magnetic disk 23, which is a recording medium to magnetically store data and a head 31 to write and read data on the magnetic disk are mounted in the base 11 of the magnetic disk apparatus 10. The magnetic disk 23 is rotated at high speed by a spindle motor 21, and the head 31 is attached via a gimbal 32 to the tip of an arm 33. The arm 33 can be moved radially by an actuator 35. In a seek operation, the arm 33 moves the head 31 to the target track, and the head 31 can read/write a data after waiting for the target sector to rotate to a position under the head. The base 11 also accommodates a printed circuit board (not shown) on which a motor driving circuit, a signal processing circuit, etc. are mounted.

As shown in FIG. 2, the magnetic disk apparatus 10 is assembled by mounting the cover 13 onto the base 11 and by driving screws into the threaded holes in the cover 13 to thereby secure the cover 13 to the base 11. A damping plate 15 is fixed in place by an insulating double-sided adhesive tape in order to suppress vibration or noise of the apparatus that can occur due to the driving of the spindle motor 21 or due to a seek operation of the arm 33. In the cover 13, a recessed portion to which the damping plate 15 is attached is formed in such a manner as to encircle the cover portion under which the spindle motor 21 is located; when the damping plate 15 is fixed to the recessed portion of the cover 13 by insulating double-sided adhesive tape, the damping plate 15 is substantially flush with the other portion of the cover 13 to which the damping plate 15 is not attached. The base 11 and the cover 13 are each formed from a metal such as stainless steel, and an electrical connection between them is maintained by the metal screws fixing them together. However, the damping plate 15 is electrically floating because it is fixed in place using an insulating double-sided adhesive tape.

The electrically floating damping plate 15 may become electrically charged due to the imbalance of ions generated by the ionizer provided to neutralize static electricity or due to rubbing by an operator's glove during the manufacturing process of the magnetic disk apparatus 10. When the magnetic disk apparatus 10 with the damping plate 15 thus charged is set in manufacturing equipment, if the damping plate 15 contacts a conductive portion of the manufacturing equipment, an abrupt discharge occurs from the charged damping plate 15 to the manufacturing equipment. As a result of such a discharge, a voltage due to electromagnetic induction occurs in a magnetic head pattern printed on the gimbal and connecting to the magnetic head core, and a secondary induced current flows. With the recent trend toward lower electrostatic breakdown voltages of GMR (Giant Magneto-Resistive) heads or TMR (Tunnel Magneto-Resistive) heads, the magnetic head can be destroyed by the induced current.

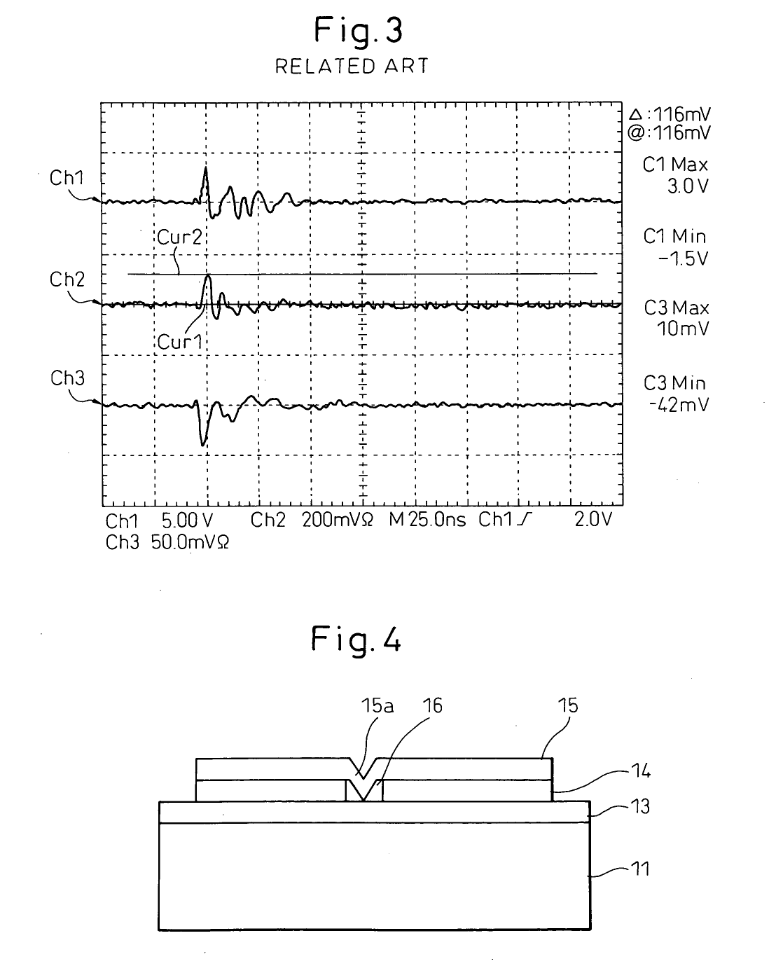

FIG. 3 is a diagram showing the measurements of the voltage and current induced in the GMR head pattern. The voltage and current were measured in the situation where the damping plate of an magnetic disk apparatus with a GMR head was rubbed by an operator's glove and subsequently discharged using an electrostatic discharge (ESD) checker to check for the discharge of static electricity.

Three waveforms, channel 1 (Ch1) to channel 3 (Ch3), are shown in this order from top to bottom in FIG. 3. The range of channel 1 is 5.00 V, the range of channel 2 is 200 mV, and the range of channel 3 is 50.0 mV. The time is plotted along the abscissa, the unit being 25.0 ns. Further, the setting is made so that a trigger occurs after the waveform of channel 1 rises and exceeds 2.0 V.

Channel 1 is a waveform showing the electrostatic discharge from the damping plate; the notes “Max 3.0 V” and “Min −1.5 V” in the right-hand side margin of the graph indicate that a discharge of a maximum of 3.0 V occurred. Channel 2 is a waveform representing the voltage induced in the GMR head pattern, and indicates that a voltage of 116 mV was generated which is shown by a gap (A116 mV) between horizontal cursors Curl and Cur2. Channel 3 is a graph showing the secondary induced current flowing due to the voltage induced in the head pattern; voltage values “Max 10 mV” and “Min −42 mV” are shown in the right-hand side margin of the graph. As a secondary induced current of 1 mA flows at 5 mV, it follows that, at −42 mV which is the largest in magnitude, a current of about 8 mA flows. The current of this magnitude does not result in the destruction of the GMR head, but if the damping plate was charged to higher than 3.0 V, for example, to 5.0 V, and this electricity was discharged, the GMR head would be destroyed.

Further, if the magnetic disk damping plate delivered to the customer is electrically charged, an ill effect may be caused to the magnetic head if the damping plate is discharged by contact with a conductive portion of the customer's product when assembling the magnetic disk into the customer's product. Furthermore, this discharge can cause electrostatic breakdown of electronic components in the customer's product that are sensitive to electrostatic discharge.

The present invention, based on the discovery that an electrically floating damping plate tends to cause an electrostatic discharge, provides a structure that can avoid electrostatic discharge of the damping plate by electrical connecting the damping plate to the cover or by devising means that makes electrostatic discharge from the damping plate difficult.

The embodiments of the present invention will be described below with reference to the drawings.

### Embodiment 1

FIG. 4 to 6 are schematic cross-sectional views for explaining a magnetic disk apparatus according to a first embodiment of the present invention. According to the embodiment, the damping plate is electrically connected to the cover via a through-hole opened in an insulating double-sided adhesive tape which is used to attach the damping plate to the cover.

In the example shown in FIG. 4, the through-hole 16 is formed in the double-sided adhesive tape 14, and the damping plate 15 is provided with a protrusion 15a whose height is approximately equal to the thickness of the adhesive tape 14. The damping plate 15 is held electrically connected to the cover 13 by the protrusion 15a. Accordingly, any charge occurring on the damping plate 15 due, for example, to friction is transferred via the protrusion 15a to the cover 13 and then to the base 11 for grounding, and the damping plate 15 is thus prevented from becoming charged.

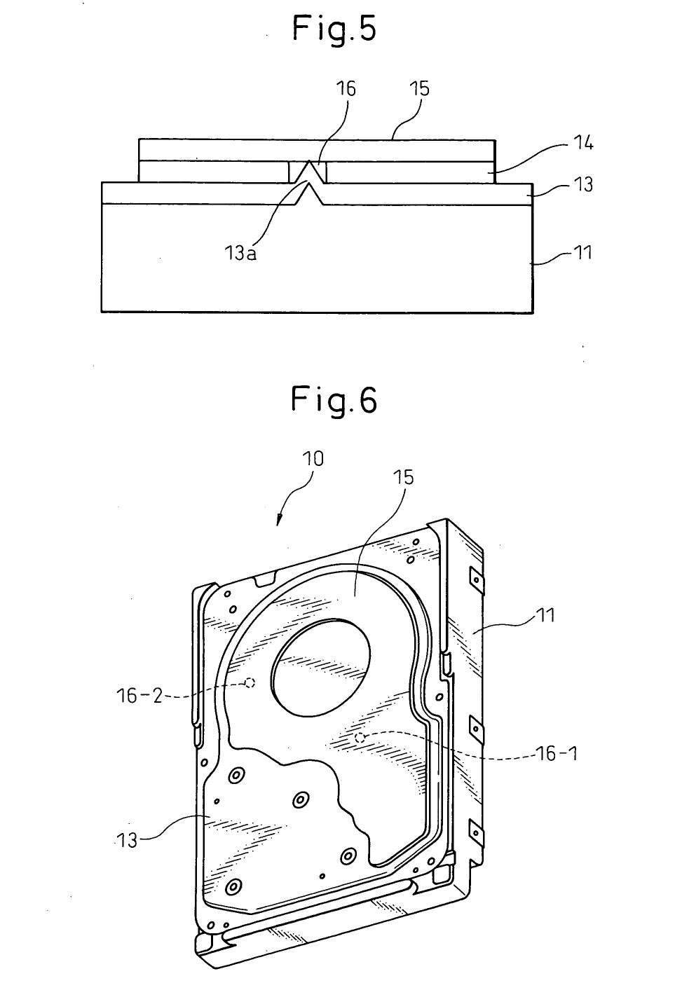

In the example shown in FIG. 5, to provide an electrical connection between the damping plate 15 and the cover 13, a protrusion 13a whose height is approximately equal to the thickness of the double-sided adhesive tape 14 is formed on the cover 13 at a position corresponding to the through-hole 16 of the double-sided adhesive tape 14. The structure shown in FIG. 5, like FIG. 4, can prevent the damping plate 15 from becoming charged. In FIGS. 4 and 5, the protrusions 15a and 13a are each shown as having a sharply pointed tip, but the tip may be formed in the shape of a rounded end or a flat end to provide a contact face.

FIG. 6 is a diagram showing the position where the through-hole of the double-sided adhesive tape is formed, that is, the position where the protrusion of the damping plate or the cover is formed. The double-sided adhesive tape 14 (FIGS. 4 and 5) attached over the entire back surface of the damping plate 15 has a through-hole 16-1 formed in a position corresponding approximately to the center of the damping plate 15 and another through-hole 16-2 formed in some other suitable position. Protrusions 15a (FIG. 4) or 13a (FIG. 5) are formed so as to electrically connect the damping plate 15 and the cover 13 via the through-holes 16-1 and 16-2. The damping plate 15 and the cover 13 need only be electrically connected at least at one position, but it is preferable to provide connections at two or more positions in order to ensure reliable contact between the damping plate 15 and the cover 13.

Further, any suitable shape can be employed for the protrusion formed on the damping plate 15 or the cover 13. For example, a strip-like protrusion may be formed on the surface of the damping plate in such a manner as to split the damping plate into two sections; in this case, the double-sided adhesive tape is also split into two sections which are then attached to the damping plate, avoiding the position of the strip-like protrusion. If the damping plate has an opening, a ring-shaped protrusion may be formed in such a manner as to encircle the opening; in this case, the double-sided adhesive tape is attached to the area outward of the ring-shaped protrusion.

### Embodiment 2

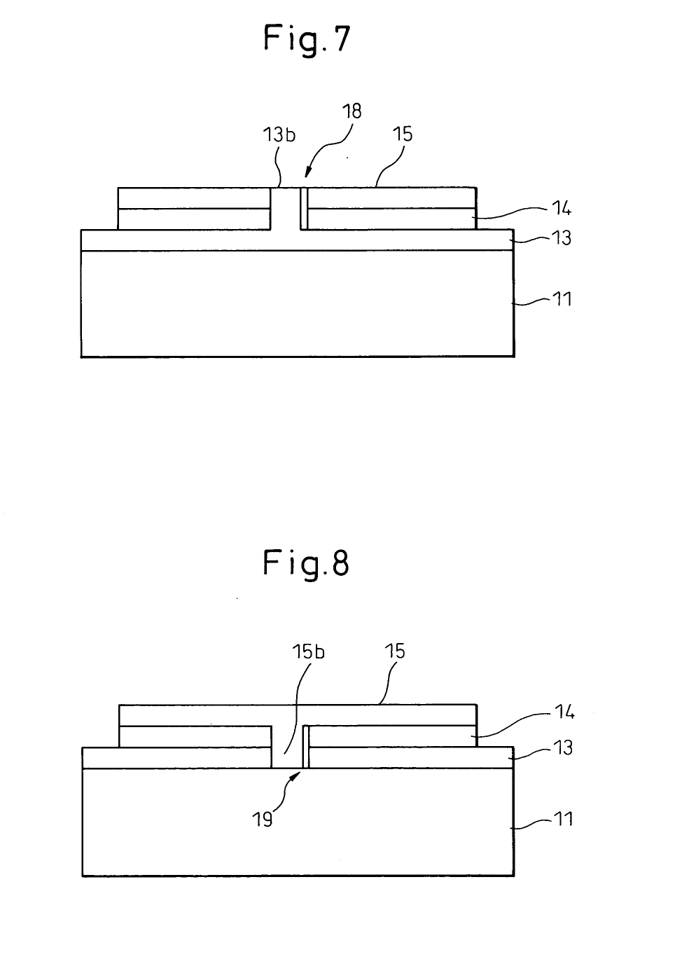

FIGS. 7 and 8 show a second embodiment of the present invention. In FIG. 7, a through-hole 18 is formed passing through the double-sided adhesive tape 14 and the damping plate 15. A protrusion 13b having a diameter slightly smaller than the diameter of the through-hole 18 is formed on the cover 13. The protrusion 13b is inserted in the through-hole 18 and the damping plate 15 is pressed in one direction and fixed in place with the interior surface of the through-hole 18 of the damping plate 15 contacting the side face of the protrusion 13b. In this way, the damping plate 15 can be electrically connected to the cover 13. In FIG. 7, the height of the protrusion 13b formed on the cover 13 is made equal to the depth of the through-hole 18 passing through the double-sided adhesive tape 14 and the damping plate 15. However, it is only required that the interior surface of the through-hole 18 be made to contact the side face of the protrusion 13b. Therefore, the height of the protrusion 13b to be formed on the cover 13 need not necessarily be made equal to the combined thickness of the double-sided adhesive tape 14 and the damping plate 15. This provides greater freedom in design.

In the example shown in FIG. 8, a through-hole 19 is formed passing through the double-sided adhesive tape 14 and the cover 13. A protrusion 15b having a diameter slightly smaller than the diameter of the through-hole 19 is formed on the damping plate 15. The protrusion 15b is inserted in the through-hole 19 and the damping plate 15 is pressed in one direction and fixed in place with the side face of the protrusion 15b of the damping plate 15 contacting the interior surface of the through-hole 19. In this way, the damping plate 15 can be electrically connected to the cover 13. In the structure of FIG. 8 also, the side face of the protrusion 15b of the damping plate 15 need only be made to contact the interior surface of the through-hole 19 of the cover 13. The height of the protrusion 15b to be formed on the damping plate 15 need not be strictly determined.

### Embodiment 3

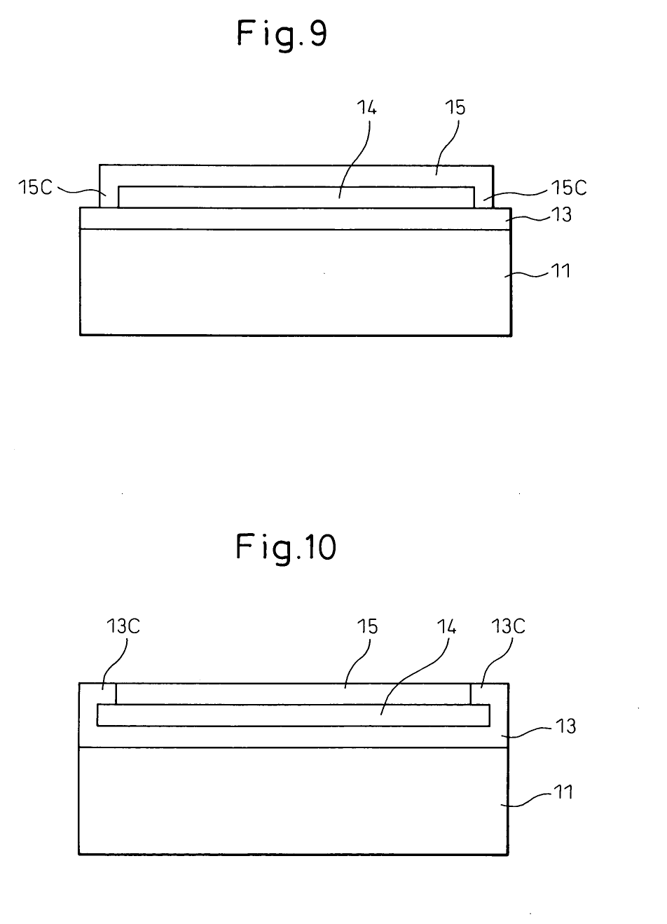

FIGS. 9 and 10 are diagrams for explaining a third embodiment of the present invention. In the third embodiment, a protrusion is formed along an outer edge of the damping plate or the cover to provide an electrical connection therebetween at a position outside the double-sided adhesive tape.

In the example shown in FIG. 9, a protrusion 15c is formed along a portion of the periphery of the damping plate 15 which is attached to the cover 13 with a double-sided adhesive tape 14. There is no need to form a through-hole in the double-sided adhesive tape, but only the protrusion 15c whose protruding height is equal to the thickness of the double-sided adhesive tape is formed, and the end face of the protrusion 15c is made to contact the cover 13 to provide an electrical connection between the damping plate 15 and the cover 13. In FIG. 9, two protrusions 15c are provided at different positions, but the cover and the damping plate need only be electrically connected at least at one position. However, it is preferable to provide protrusions at two or more positions in order to provide a reliable electrical connection. The protrusions are not limited to any specific shape. It is also possible to provide a protrusion or bent portion continuously around the entire periphery of the damping plate 15.

In the example shown in FIG. 10, a C-shaped protrusion 13c is curved upward so as to hold the double-sided adhesive tape therein. The C-shaped protrusion 13c is formed along a portion of the periphery of the cover 13 so that the end face of the protrusion 13c contacts the end face of the damping plate 15. In this case also, the protrusion may be provided only at one position, but it is preferable to provide protrusions at two or more positions in order to provide a reliable electrical connection. The protrusion 13c can be formed in a suitable size and at a suitable position on the periphery of the cover 13 as long as the protrusion 13c is formed so that its end face contacts the end face of the damping plate 15. However, it must be formed so that its presence does not interfere with the work to be performed when attaching the double-sided adhesive tape 14.

### Embodiment 4

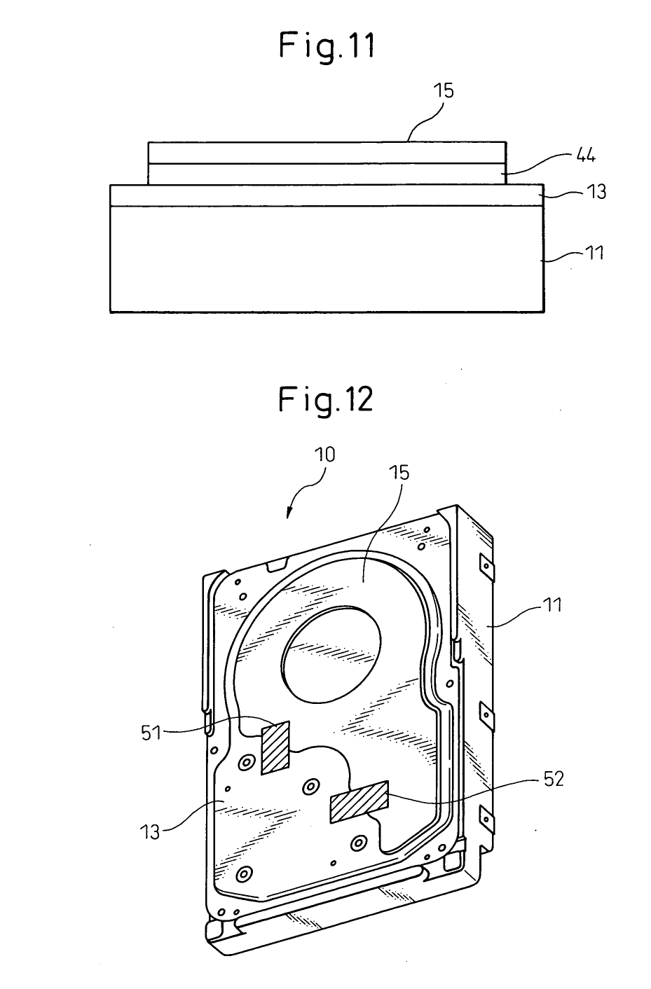

FIG. 11 is a schematic cross-sectional view for explaining a third embodiment in which the electrical connection between the damping plate and the cover is provided by an electrically conductive double-sided adhesive tape. In this embodiment, the damping plate 15 is attached, using an electrically conductive double-sided adhesive tape 44, to the cover 13 which is mounted to seal the base 11. Preferably, the conductive double-sided adhesive tape is formed from a material that exhibits a resistance value of 10⁵ Ω or less. For example, double-sided adhesive tape made of carbon, a tape made of a copper-plated fabric both sides of which are coated with a pressure-sensitive conductive adhesive, or a tape made of an aluminum foil both sides of which are coated with a pressure-sensitive conductive adhesive can be used as the conductive double sided adhesive tape. The temperature of the magnetic disk apparatus rises during operation, and gases may be generated from the double-sided adhesive tape used to mount the damping plate. The enclosure of the magnetic disk apparatus is provided with tiny holes communicating with the exterior of the enclosure to make the interior pressure of the enclosure equal to the exterior pressure. To prevent the gases generated from the double-sided adhesive tape from entering the enclosure through the tiny holes, it is preferable to use a conductive double-sided adhesive tape that does not easily emit gases. One example of the conductive double-sided adhesive tape that does not easily emit gases is a tape used for holding a specimen in a scanning electron microscope. The tape of this kind has a conductive filler made of carbon powder, and the base material is a 0.07-mm thick insulating nonwoven fabric on each side of which an adhesive material is applied to a thickness of 0.045 mm; its electrical resistance is 50 Ω/inch².

In this embodiment, by just replacing the conventional insulating double-sided adhesive tape with an electrically conductive tape, an electrical connection can be provided between the damping plate 15 and the cover 13, and the damping plate 15 can be prevented from becoming charged. Depending on applications, an electrically conductive adhesive may be used instead of the conductive double-sided adhesive tape.

### Embodiment 5

FIG. 12 is a diagram for explaining a fifth embodiment. In the fifth embodiment, the damping plate 15 is attached to the cover 13 by using an insulating double-sided adhesive tape, as in the prior art magnetic disk apparatus, but the difference is that the cover 13 and the damping plate 15 are electrically connected by attaching electrically conductive tapes 51 and 52 between them.

This embodiment can be applied to the prior art magnetic disk apparatus without requiring any special design changes, and accumulation of charge on the damping plate 15 can be prevented in a simple manner. In FIG. 11, two conductive tapes 51 and 52 are shown, but the number of conductive tapes and the shape of the tapes are not specifically limited, the only requirement being that at least one conductive tape, for example, about 1 cm square, be attached. However, to provide a reliable electrical connection, it is desirable to attach two or more conductive tapes. Also, a conductive tape may be attached along the entire periphery of the damping plate 15 in such a manner to connect the damping plate 15 and the cover 13. As shown, the cover portion under which the spindle motor 21 is located is exposed in the opening formed in the damping plate 15. A conductive tape may be attached so as to connect the periphery of the opening of the damping plate 15 and with the cover 13. Any kind of tape can be used as long as it is electrically conductive, but among metallic tapes, generally, a copper foil tape is preferred to an aluminum foil tape because the former is less prone to oxidation than the latter.

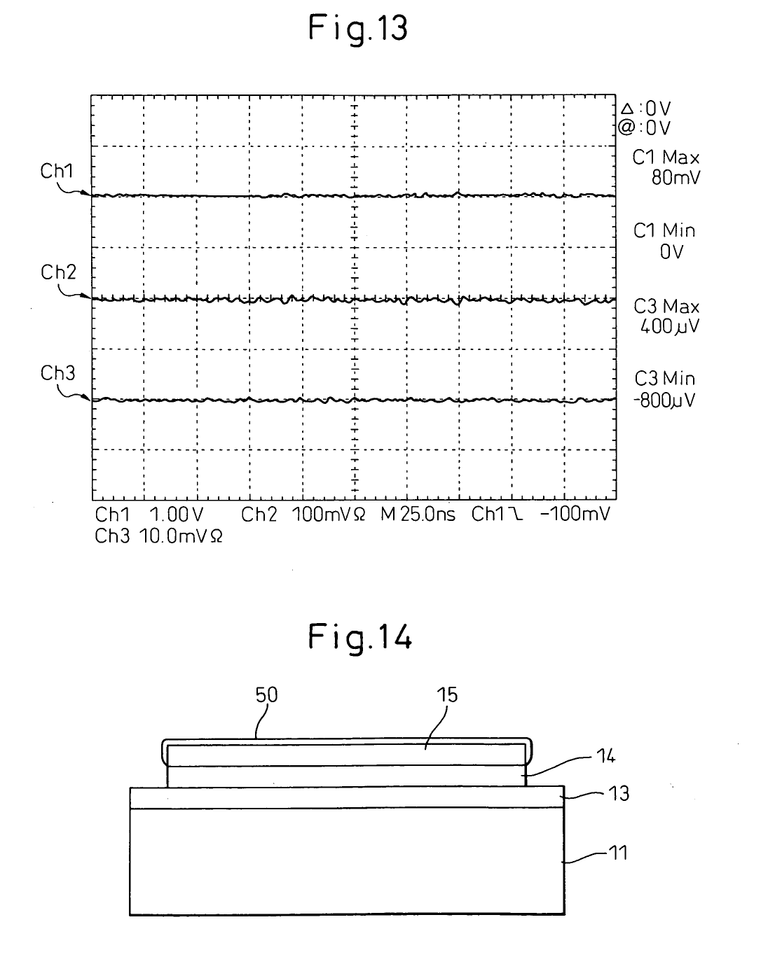

FIG. 13 is a graph showing the effect and advantage of the first to fifth embodiments. An experiment similar to that conducted on the prior art magnetic head apparatus, the results of which were previously shown in FIG. 3, was conducted on a magnetic disk apparatus equipped with a GMR head and having a damping plate electrically connected to the cover. That is, the damping plate electrically connected to the cover was rubbed by an operator's glove and thereafter connected to ground by using an ESD checker to check the discharge of static electricity, and the electrostatic discharge and the voltage and current induced in the head pattern were measured.

In FIG. 13, the uppermost channel 1 (Ch1) shows the electrostatic discharge from the damping plate, the middle channel 2 (Ch2) shows the voltage induced in the head pattern, and the lowermost channel 3 (Ch3) shows the induced current flowing due to the voltage induced in the head pattern. As shown in FIG. 13, while only slight variations are observed on channels 1 and 2, neither channel shows the occurrence of discharge. In particular, channel 2 shows that the voltage induced in the head pattern is zero. As shown, when the damping plate and the cover are electrically connected, electrostatic discharge does not occur, and accordingly, a secondary induced current that would adversely affect the head does not occur. This shows that any charge occurring on the damping plate due to the friction is quickly dissipated to ground via the cover and the base, and does not accumulate on the damping plate.

### Embodiment 6

In the first to fourth embodiments, any charge occurring on the damping plate was dissipated to ground via the cover, but prevention of electrostatic discharge can also be accomplished by preventing the discharging of stored charge rather than preventing the accumulation of charge.

FIG. 14 is a diagram for explaining a sixth embodiment. In FIG. 14, as in the prior art, the damping plate 15 is fixed, via an insulating double-sided adhesive tape 14, onto the cover 13 which is mounted to seal the base 11. The difference from the prior art is that a coating 50 of a high-resistance material is formed over the externally exposed surface of the damping plate 15. Discharge that occurs when an electrically floating conductor contacts another conductor causes the most detrimental effect to the magnetic head and other circuit components. Therefore, the high-resistance coating 50 is applied to the damping plate, an electrically floating conductor, to prevent the discharging from occurring due to the contact with another conductor. The high-resistance material here refers to an antistatic material having a resistance value of 10⁵ to 10¹² Ω or an insulating material having a resistance value higher than 10¹² Ω. It is preferable to use an antistatic material having a resistance value of 10⁵ to 10¹² Ω; among others, it is further preferable to use an antistatic material having a resistance value of 10⁷ to 10⁹ Ω. In FIG. 14, the high-resistance coating 50 is applied over the externally exposed portions of the damping plate 15, but alternatively, the entire structure of the damping plate 15 may be covered with the high-resistance coating 50.

Means for coating the damping plate 15 with a high-resistance material includes spray coating or electrodeposition of a high-resistance material; alternatively, a tape made of a high-resistance material may be attached, or the entire structure of the damping plate may be wrapped with a high-resistance material.

What is claimed is:

1. A magnetic disk apparatus comprising:
an electrically conductive enclosure which accommodates at least a magnetic storage medium and a head for writing/reading information on said magnetic storage medium;
an electrically conductive damping plate which is attached, via an insulating member, to one face of said electrically conductive enclosure in order to suppress vibration of said electrically conductive enclosure; and
at least one electrical connecting member which electrically connects said damping plate to said electrically conductive enclosure.

2. A magnetic disk apparatus as claimed in claim 1, wherein said insulating member is an insulating double-sided adhesive tape, and
said electrical connecting member is a protrusion protruding from said damping plate or said electrically conductive enclosure.

3. A magnetic disk apparatus as claimed in claim 2, wherein said insulating double-sided adhesive tape has at least one through-hole, and
said protrusion passes through said through-hole.

4. A magnetic disk apparatus as claimed in claim 1, wherein said damping plate has a through-hole communicating with said through-hole, and
said protrusion is formed protruding from said one face of said electrically conductive enclosure, and contacts an interior side face of said through-hole formed in said damping plate.

5. A magnetic disk apparatus as claimed in claim 1, wherein said electrically conductive enclosure has a through-hole communicating with said through-hole, and
said protrusion is formed protruding from said damping plate, and contacts an interior side face of said through-hole formed in said electrically conductive enclosure.

6. A magnetic disk apparatus as claimed in claim 1, wherein said electrical connecting member is at least one electrically conductive tape which is attached so as to electrically connect a surface of said electrically conductive enclosure and a surface of said damping plate.

7. A magnetic disk apparatus as claimed in claim 6, wherein said electrically conductive tape is a metal tape.

8. A magnetic disk apparatus as claimed in claim 6, wherein said electrical connecting member is attached over a predetermined length along an outer edge of said damping plate.

9. A magnetic disk apparatus comprising:
an electrically conductive enclosure which accommodates at least a magnetic storage medium and a head for writing/reading information on said magnetic storage medium;
an electrically conductive member; and
an electrically conductive damping plate which is attached via said electrically conductive member to one face of said electrically conductive enclosure in order to suppress vibration of said electrically conductive enclosure.

10. A magnetic disk apparatus as claimed in claim 9, wherein said electrically conductive member is formed from an electrically conductive double-sided adhesive tape having a resistance value of 105 Q or less.

11. A magnetic disk apparatus comprising:
an electrically conductive enclosure which accommodates at least a magnetic storage medium and a head for writing/reading information on said magnetic storage medium; and
an electrically conductive damping plate which is attached to one face of said electrically conductive enclosure in order to suppress vibration of said electrically conductive enclosure, wherein
at least an externally exposed surface of said damping plate is covered with a high-resistance material.

12. A magnetic disk apparatus as claimed in claim 11, wherein said high-resistance material has a resistance value larger than 10⁵ Ω but not larger than 10¹² Ω.

13. An electrically conductive damping plate which is attached to an electrically conductive enclosure, wherein
an electrical connecting member for electrical connecting to said electrically conductive enclosure is provided protruding from one face of said damping plate.

14. An electrically conductive enclosure which accommodates at least a magnetic storage medium and a head for writing/reading information on said magnetic storage medium, and to which an electrically conductive damping plate is attached, wherein
an electrical connecting member for electrical connecting to said damping plate is provided protruding from a face to which said damping plate is attached.
